(19) United States
(12) Patent Application Publication
(10) Pub. No.: US 2012/0269375 A1
(43) Pub. Date: Oct. 25, 2012

(54) EARPHONE

(76) Inventors: Chee Keong Tan, Singapore (SG); Peng Koon Quek, Singapore (SG); Virgilio Pascua, JR., Singapore (SG)

(21) Appl. No.: 13/391,959

(22) PCT Filed: Aug. 24, 2010
(86) PCT No.: PCT/EP10/62317

§ 371 Date: Mar. 14, 2012

(30) Foreign Application Priority Data
Aug. 24, 2009 (DE) 10 2009 038 372.7

(51) Int. Cl. H04R 1/10

(52) U.S. Cl. 381/380

(57) ABSTRACT

There is provided an earphone comprising a housing having a fist and a second end. The housing has a first opening at the first end and a second opening at the second end for receiving an electroacoustic reproduction transducer. The earphone further has a second pressure reducing unit which is placed over the second opening to reduce the dynamic water pressure on the second opening, and a first pressure reducing unit which is placed over the first opening to reduce the dynamic water pressure on the first opening. In addition a second water-tight but acoustically transparent film is provided in the interior of the housing over the second opening to water-tightly close the second opening. A first water-tight but acoustically transparent film is placed in the interior of the housing over the first hole to water-tightly close the first hole.

The present application claims priority from PCT Patent Application No. PCT/EP2010/062317 filed on Aug. 24, 2010, which claims priority from German Patent Application No. DE 10 2009 038 372.7 filed on Aug. 24, 2009, the disclosures of which are incorporated herein by reference in their entirety.

### BACKGROUND OF THE INVENTION

1. Field of the Invention

The present invention concerns an earphone.

2. Description of Related Art

Earphones such as for example in-ear earphones are sufficiently known and are preferably worn inter alia in sporting activities even over a prolonged period of time. In that respect it can happen that the in-ear earphones can he soiled by perspiration, earwax or the like.

As general technological background attention is directed to DE 10 2007 037 876 B3, EP 1 915 032 A2, FR 2 803 152 A1, DE 10 2007 058 987 B3 and EP 0 310 866.

### SUMMARY OF THE INVENTION

Therefore an object of the present invention is to provide an earphone which has improved an cleaning option.

Thus there is provided an earphone, an earbud, an in-ear earphone or a headset comprising a housing having a first and a second end. The housing has a first opening at the first end and a second opening at the second end for receiving an electroacoustic reproduction transducer. The in-ear earphone further has a first pressure reducing unit which is placed over the first opening to reduce the (dynamic) water pressure on the first opening, and a second pressure reducing unit which is placed over the second opening to reduce the (dynamic) water pressure on the first opening and a first water-tight but acoustically transparent film is provided in the interior of the housing over the first opening to water-tightly close the first opening. In addition a second water-tight but acoustically transparent film is placed in the interior of the housing over the second opening to water-tightly close the second opening.

Thus there can be provided an in-ear earphone which for example can be cleaned under a water faucet in a jet of water without the acoustic properties of the earphone being adversely affected in that case.

In an aspect of the present invention the second pressure reducing unit is in the form of a resonator having a number of openings or holes.

In a further aspect of the invention the first pressure reducing unit is in the form of a plate for at least partially closing the first opening.

The present invention is based on the notion of being able to clean an (in-ear) earphone for example under flowing water. At its sound outlet (end towards the ear) the in-ear earphone has a water-tight film which covers or covers over the entire sound outlet. The (in-ear) earphone further has a cover portion which for example can be in the form of a resonator. The cover portion is placed from the outside over the water-tight film and covers the film. The cover portion represents a pressure reducing unit for reducing a (dynamic) water pressure which can build up with flowing water at the outside of the pressure reducing unit, on the film. The cover portion preferably has a plurality of openings or holes. The cover portion is fixed to the housing of the earphone. An annular ear pad can be fitted onto the cover portion. In addition a further opening, for example a bass hole, can optionally be provided on the housing of the in-car earphone. To seal off that opening it is possible to provide a second water-tight film which can be provided at the inside of the housing. Optionally the opening can be closed for example by means of a plate. When the plate is placed in or on the opening a tunnel can then be formed. The configuration of the cover portion and the plate can preferably be such that a dynamic (water) pressure on the second film is reduced. In that way the resonator and the plate can be in the form of dynamic (water) pressure reducing units.

Further configurations of the invention are subject-matter of the appendant claims.

### BRIEF DESCRIPTION OF THE DRAWINGS

FIG. 1 shows a diagrammatic view of the various parts of an in-ear earphone according to a first embodiment; and

FIG. 2 shows a diagrammatic sectional view of the in-ear earphone according to a second embodiment.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

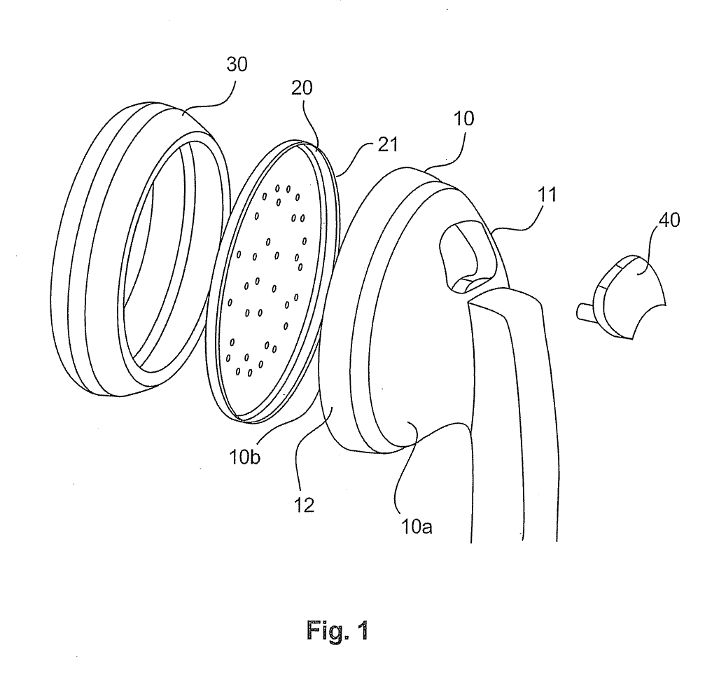

FIG. 1 shows a diagrammatic view of the parts of in-ear earphone according to a first embodiment. The in-ear earphone has a housing 10 having a first hole or opening 11 and a second opening 12 for receiving an electroacoustic reproduction transducer. The in-ear earphone further has a second pressure reducing unit (for example in the form of a cover unit 20) as well as an ear pad 30. The second pressure reducing unit 20 is fixed by means of the fixing unit 30 over the opening 12 of the housing 10. An annular ear pad 30 is fitted onto the pressure reducing unit 20. A first pressure reducing unit for example in the form of a plate 40 can be fixed in or on the first hole 11.

The second pressure reducing unit 20 can be in the form of a resonator and can have a plurality of openings or holes 21.

The in-ear earphone according to the first embodiment further has (not shown) water-tight but acoustically transparent films in the interior of the housing 10 in front of the first opening/hole 11 and the second opening 12, which respectively completely cover the first and second openings 11, 12.

The second pressure reducing unit 20 with its openings or holes 21 is in the form of a water pressure reducing unit, that is to say the unit provides that the dynamic water pressure which occurs under flowing water outside the housing is only passed at reduced pressure to the water-tight film at the opening 12. A corresponding consideration applies for the hole 11 if the second pressure reducing unit 40 is placed in the opening 11.

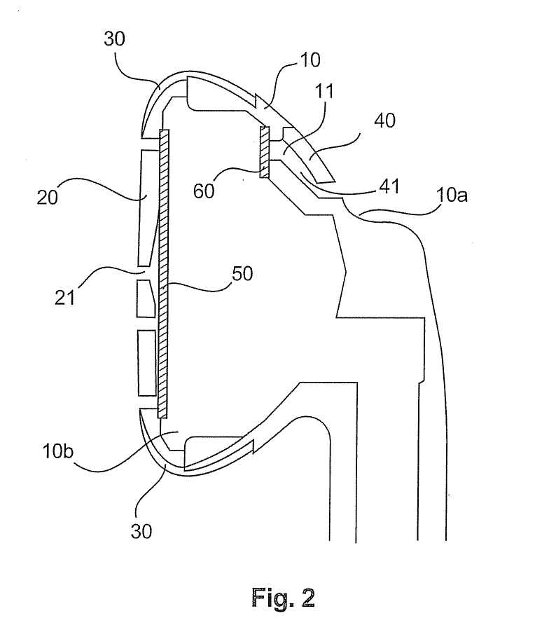

FIG. 2 shows a diagrammatic sectional view of an in-ear earphone according to a second embodiment. In this case the in-ear earphone according to the second embodiment can be based on the in-ear earphone according to the first embodiment. The in-ear earphone has a housing 10 having first and second ends 10a and 10b. Provided in the region of the first end 10a of the housing 10 is a first opening or hole 11. Provided in the region of the second end 10b of the housing 10 is a large second opening 12. A first water-tight film 60 is provided in the region of the first opening 11. A second water-tight film 50 is provided in the interior of the housing in the region the second opening 12. A second pressure reducing unit (cover unit) 20 is placed from the exterior over the second water-tight film 50 and over the second opening 12. The cover unit 20 can be fixed for example by means of a fixing unit 30 to the housing 10 or to the second end 10b of the housing 10. An annular ear pad 30 can be fitted onto the cover unit 20.

The second pressure reducing unit (cover unit) 20 can be provided in the form of a resonator having a plurality of openings or holes 21.

The first opening 11 can be in the form of a bass hole when the second pressure reducing unit (the plate) 40 is placed in the hole. In that case a passage or tunnel 41 can be produced.

The water-tight film according to the first or second embodiment preferably enjoys acoustic transparency.

The ear pad of the first or second embodiment can for example comprise rubber. The film must be both water-tight and also acoustically transparent. Those mutually conflicting demands can be met according to the invention with special films which for transmission of the sound have pores which however are so small that they can nonetheless retain water in a limited pressure range. The pressure reducing units prevent the dynamic pressure which builds up in flowing water at the outside surface of the earphone reaching the film. A specially provided film having pores can withstand the pressure reduced in that way. The water-tight film or fabric has for example a pore size of apparatus 51 μm, an open area of 18%, a thickness of 108 μm, a weight of 86 g/m², air permeability of 20 mm water gauge=2990 l/m² S and a specific air flow resistance of 45 MKS Rayls=45 Pa s/m. The specific air flow resistance is also referred to as characteristic acoustic impedance and in acoustics specifies the ratio of sound pressure to sound velocity. That value thus serves as a measure in respect of sound transparency, a small value denoting a high level of sound transparency.

In a further embodiment of the invention the water-tight film is in the form of a fabric, cloth or fibers. The film can be in the form of a Saatifil mesh with a pore. size of between 18 and 120 μm, a thickness of between 48 and 125 μm, a weight of between 25 and 85 μm and a specific air flow resistance of between 6 and 260 MKS Rayls.

Described in the Table hereinafter are a plurality of meshes which can be used as the water-tight film according to the embodiments of the invention.

| | Specific air flow resistance | | | | |
|---|---|---|---|---|---|
| | | CGS Acoustic | Pore | | |
| | [MKS | Ohm⁽²⁾ over | size | Thickness | Weight |
| | Rayls]⁽¹⁾ | 1 cm² | [μm] | [μm] | [g/m²] |
| Saatifil | 6 | 0.6 | 105 | 65 | 25 |
| Acoustex 006 | | | | | |
| Saatifil | 10 | 1.0 | 120 | 105 | 50 |
| Acoustex 010 | | | | | |
| Saatifil | 25 | 2.5 | 55 | 50 | 25 |
| Acoustex 025 | | | | | |
| Saatifil | 32 | 3.2 | 38 | 48 | 25 |
| Acoustex 032 | | | | | |
| Saatifil | 45 | 4.5 | 50 | 110 | 70 |
| Acoustex 045 | | | | | |
| Saatifil | 90 | 9.0 | 40 | 125 | 85 |
| Acoustex 090 | | | | | |
| Saatifil | 145 | 14.5 | 25 | 70 | 55 |
| Acoustex 145 | | | | | |
| Saatifil | 160 | 16.0 | 20 | 60 | 45 |
| Acoustex 160 | | | | | |
| Saatifil | 260 | 26.0 | 18 | 60 | 50 |
| Acoustex 260 | | | | | |

NOTES:
⁽¹⁾= [Pa s/m]
⁽²⁾= [Microbar s/cm³]

Preferably the Saatifil Acoustex 025, 032, 045, 090 or 145 are used. Saatifil Acoustex is a registered trademark of Saatifil.

That film can represent a mesh of polyester monofilament fiber.

The air flow test is effected with a laminar air flow. The flow rates are <0,3 m/s with a level of accuracy of 0.1 Pa.

Alternatively to the above-described in-ear earphones the invention can also be used in relation to an earphone, an earbud or in a headset.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. An earphone, in particular an earbud, comprising
a housing having including:
a first end;
a second end;
a first opening at the first end; and
a second opening at the second end for receiving an electroacoustic reproduction transducer,
a first pressure reducing unit which is placed over the first opening to reduce the dynamic water pressure on the first opening; and
a second pressure reducing unit which is placed over the second opening to reduce a dynamic water pressure on the second opening; and
a first water-tight but acoustically transparent film which is placed in the interior of the housing over the first opening to water-tightly close the first opening; and
a second water-tight but acoustically transparent film which is provided in the interior of the housing over the second opening to water-tightly close the second opening;
wherein the water-tight film:
is in the form of a fabric with a pore size of between 18 and 120 μm;
has a thickness of between 48 and 125 μm;
has a weight of between 25 and 85 μm; and
has a specific air flow resistance of between 2 and 260 Pa s/m.

2. The earphone as set forth in claim 1;
wherein the second pressure reducing unit is in the form of a resonator having a number of openings or holes.

3. The earphone as set forth in claim 1;
wherein the first pressure reducing unit is in the form of a plate for at least partially closing the first opening.

4. (canceled)

5. The earphone as set forth in claim 2;
wherein the first pressure reducing unit is in the form of a plate for at least partially closing the first opening.
